(19) United States
(12) Patent Application Publication
(10) Pub. No.: US 2004/0151400 A1
(43) Pub. Date: Aug. 5, 2004

(54) Method and apparatus for recording jag-free image

(76) Inventor: Yoshiharu Sasaki, Shizuoka (JP)

Correspondence Address: YOUNG & THOMPSON, 745 SOUTH 23RD STREET 2ND FLOOR, ARLINGTON, VA, 22202

(21) Appl. No.: 10/745,698

(22) Filed: Dec. 29, 2003

(30) Foreign Application Priority Data
Dec. 27, 2002 (JP) 2002-382583

(51) Int. Cl. G06K 9/40; G06K 9/00

(52) U.S. Cl. 382/269; 382/141

(57) ABSTRACT

A method and an apparatus for recording an image in two steps of scanning an image recording material with a light beam in primary and secondary scan directions to record an image accompanied by jaggy or stairstep border lines or border edges that are oblique relative to the scan directions and further scanning the image recording material in an oblique direction along the jaggy border line of the image to smooth the jaggy border lines or border edges, either after or before the first scan.

### BACKGROUND OF THE INVENTION

1. Field of the Invention

The present invention relates to an image recording method of recording an image on a recording material and, more particularly, to a jag-free image recording method of recording an image, such as a wiring pattern of an electric circuit, without jugged border edges,

2. Description of Related Art

It has been well known in the art to form a pattern such as a wiring pattern for a printed circuit on a circuit board using an image recording methods. Such an image recording method is known from, for example, Japanese patent application No. 2002-171902 filed by the same applicant as this application. Reference is made to FIG. 8 for the purpose of providing a brief description of the image recording method, more specifically a printed circuit producing method, disclosed in the above mentioned publication in which a printed circuit is produced by using a dry film resist in the form of a solid film.

As shown in FIG. 8, a method of producing a printed circuit board comprises the following steps:

(1) coating a through-plated copper-clad lamination with a photoresist layer by heating a dry film resist put on the lamination;

(2) exposing the through-plated copper-clad lamination to a light pattern of a given wiring pattern to solidify the exposed pattern of the photoresist layer,

(3) liquating unsolidified or alkali-soluble portions of the photoresist layer on the copper-clad lamination by means of an alkalescent aqueous solution;

(4) removing the bare copper by means of an etching solution; and

(5) liquating the photoresist layer still remaining on the copper-clad lamination by means of a strong alkaline aqueous solution.

As shown in FIG. 8, a copper-clad lamination having through-platings generally comprising an insulating substrate 80 is coated with a thin copper foil 81 (step A). The dry film resist in the form of a solid film, that comprises first and second photoresist layers 85 and 86 formed on a transparent substrate 84 is lapped over each surface of the copper-clad substrate 80 with the second photoresist layer 86 in contact with the copper layer 81 (step B). The coated substrate 80 is selectively exposed to a light pattern provided by a laser beam 87 in an ultraviolet region or in a visible region correspondingly to a predetermined wiring pattern including the through holes 83 (step C). Specifically, the dry film resist is illuminated in a pattern in which the photoresist layers 85 and 86 are desired to remain on the copper-clad substrate 80 by the laser beam 87 through the transparent substrate 84 as indicated by circle marks. Portions of the dry film resist marked X that are to be removed later are isolated from the laser beam 87. The laser pattern is provided using any one of known laser exposure devices. The dry film resist exposed to the laser beam 87 and cured or solidified turns hardly soluble with an alkalescent aqueous solution such as a sodium carbonate solution.

After removing the transparent substrate 84 from the coated substrate 80, the portions of the dry film resist that was isolated from the laser beam 87 are liquated by means of an alkalescent aqueous solution (step D). As a result, the dry film resist still remaining on the coated substrate 80 in the exposed pattern and laid down over the holes 83 like what is called a tent acts as an etching resist. In accordance with known methods, the copper-clad substrate 80 is treated with a copper-etching solution to remove the copper surfaces 81 that have been uncovered completely (step E). At this juncture, since the through-platings are covered by the etching resist, namely the second photoresist material, and blocked off by the etching resist, namely the first photoresist material, the through-platings are protected from the copper-etching solution. Then, the protected copper conductors and the through-platings are cleared of the etching resist (step F). This is carried out in accordance with known methods by treatment with a strong alkaline aqueous solution of, for example, sodium hydroxide or potassium hydroxide that attacks and dissolves the etching resist but not cupper. By this means, there is obtained a double-sided printed circuit board having through-platings which may have no or only very small annular rings 81a.

In the case of recording an image on a non-flexible or hard image recording material for producing a non-flexible or hard printed circuit board, it is preferred to use an image recording apparatus such as known from, for example, Japanese patent application No. 2001-189913 filed by the same applicant as this application. Reference is made to FIGS. 9 and 10 for the purpose of providing a brief description of the image recording apparatus disclosed in the above mentioned publication.

Referring to FIGS. 9 and 10, the image recording apparatus 21 essentially comprises internal components including a recording stage 27, a recording head 29 and an image transfer film feeder unit 31 in addition to a pressure roller (not shown) and a releasing mechanism (not shown). The recording stage 27 holds a non-flexible or hard material 23 for a printed circuit board (which is hereafter referred to as a non-flexible board) that has a printing surface 23a on which a printed circuit is formed and is movable in an image recording plane. The recording head 29 is movable between a standby position and a recording position where the recording head 29 projects a laser beam onto the printing surface 23a of the non-flexible board 23. The image transfer film feeder unit 31 feeds an image transfer film onto the non-flexible board 23 held on the recording stage 27. The image transfer film is pressed down to be brought into firm contact with the printing surface 23a of the non-flexible board 23 by the pressure roller before image recording and is removed from the non-flexible board 23 by the releasing mechanism such as comprising a pressure roller, peeling claws and socket grooves after image recording.

In addition to the internal components, the image recording apparatus 21 is accompanied by external components including a board feeder unit 33 which places a stack of non-flexible boards 23 on a L-shaped rack 47, a carrying mechanism 49 operative to carry the non-flexible board 23 from the board feeder unit 33 onto the recording stage 27 in a lengthwise direction X, a retrieving mechanism 51 operative to retrieve the non-flexible board 23 from the recording stage 27 in the lengthwise direction X, and a board receiver unit 35 on which the non-flexible board 23 retrieved from the recording stage 27 are stacked. A waste box 37 is used to receive the image transfer films after use. The image recording apparatus 21 is provided with a laser shading frame 41 that encloses at least the recording stage 27, a recording unit 39 including the recording head 29 and the image transfer film feeder unit 31 to prevent leakage of a laser beam from a safety point of view. It is preferred to install the image recording apparatus 21, the board feeder unit 33 and the board receiving unit 35 in a clean room. The board feeder unit 33 bears a plurality of non-flexible boards 23 separated at regular clearances. The non-flexible board 23 is usually positioned with the printing surface 23adirected downward for protection against dusts accumulation.

As shown in FIG. 10, the carrying mechanism 49 is disposed between the board feeder unit 33 and the recording stage 27 of the image recording apparatus 21, and the retrieving mechanism 51 is disposed between the recording stage 27 of the image recording apparatus 21 and the board receiver unit 35. These carrying mechanism 49 and retrieving mechanism 51 are provided with carrier pallets 57 equipped with vacuum type suction pads 53 fixedly mounted thereon that are operative to firmly hold the non-flexible board 23. There are provided at least three, more desirably four, suction pads 53. The number of suction pads 53 may be increased or decreased according to size and shape of the non-flexible board 23. Each suction pad 53 is connected to a source of suction 55 such as a suction pump or a suction blower through an air pipe (no shown). The carrier pallet 57 is adapted to move back and force between the recording stage 27 and the carrying mechanism 49 or between the recording stage 27 and the retrieving carrier mechanism 51. The carrier pallet 57 is transported by a drive engine such as an electric motor, an air cylinder, a hydraulic cylinder or the like and is guided by means of guide rails or guide slots (not shown).

The image recording apparatus 21 is further provided with a drive control circuit operative to control the recording head 29 to record an image on the image transfer film superposed on the non-flexible board 23, a control unit 59 operative to control drive motors for the recording head 29 and the recording stage 27, respectively, the carrying mechanism 49, the retrieving mechanism 51, the source of suction 55 and the like, and an electric source 61 for supplying electric power to the control unit 59, the source of suction 55 and the drive motors. The image recording apparatus 21, more specifically the controller 59, is connected to a host computer 63 by means of a communication line so as to transmit control signals necessary to perform control of image recording and control of carrying and retrieving the non-flexible board 23. The image recording apparatus 21 has memories for data on an image representing a printed circuit pattern to be recorded by the recording unit 39 and data for identifying the image. When recording an image, the image recording apparatus 21 sends image identifying data as well as image data to the recording unit 31.

The following description will be directed to operation for carrying an on-flexible board 23 to the recording stage 27 from the board feeder unit 33. In the standby state of the image recording apparatus 21, the recording stage 27 is in position for receiving a non-flexible board 23, and the recording head 29 is in the standby position out of a field of movement of the recording stage 27 that includes first to fourth quadrants (I, II, III and IV) each having the same area as an area of the scanning stage 27. In other words, the recording stage 27 is moveable a distance twice as long as the width thereof in each of the lengthwise and transverse directions X and Y Accordingly, the recording head 29 in the starting position can make a scan of all area on the recording stage 27. It is to be noted that a scan may be made through relative movement between the scanning stage and the recording head 2 9 and, in consequence, it is allowed to move the recording stage 27 relatively to the recording head 29 fixedly positioned, to move the recording head 29 relatively to the recording stage 27 fixedly positioned, or to move both scanning stage and recording head 29 relatively to each other. The recording unit 39 has a center in line with a starting point of the recording head 29 (see FIG. 9).

The carrying mechanism 49 carries the carrier pallet 57 in a horizontal p lane in a lengthwise direction X toward the board feeder unit 33 as shown in FIG. 10, and stops the carrier pallet 57 right above a stack of non-flexible boards 33 placed on an L-shaped rack 47. Then, the carrying mechanism 49 lowers the carrier pallet 57 and stops it when the suction pads 53 reach the uppermost non-flexible board 33. Subsequently, the source of suction 55 is activated to cause the suction pads 53 to attract and lift up the non-flexible board 23 from support pins 45. The non-flexible board 23 is put with the printing surface 23a supported on the support pins 45, so that the non-flexible board 23 held by the suction pads 53 is prevented from suction marks on the printing surface 23a.

The carrier pallet 57 holding the non-flexible board 23 is carried toward the recording stage 27 of the image recording apparatus 21 in the lengthwise direction X and is once stopped immediately before the image recording apparatus 2 1. Then, the carrier pallet 57 holding the non-flexible board 23 is turned upside down to turn the printing surface 23a of the non-flexible board 23 upward. Thereafter, the carrier pallet 57 holding the non-flexible board 23 is further carried to the recording stage 27 through an egress/ingress 41a formed in the laser shielding frame 41 and positions the non-flexible board 23 right above the recording stage 27.

The recording stage 27 has a rectangular recess 71 formed in the top thereof that has a depth substantially equal to the thickness of the non-flexible board 23. The recess 71 receives the non-flexible board 23 therein. The recording stage 27 is provided with a plurality of lift pins (not shown) installed in the bottom of the recess 71 for supporting and lifting the non-flexible board 23 and offset pins (not shown) installed in two side walls adjacent to each other for urging the non-flexible board 23 against other two side walls adjacent to each other, respectively. Further, the recording stage 27 has a number of suction bores formed in the bottom and the side walls of the recess 71. These suction bores are connected to the source of suction 55 through air pipes (not shown). The suction bores arranged in the bottom of the recess 71 are used to suck air between the non-flexible board 23 and the bottom of the recess 71 of the recording stage 27 so as thereby to firmly attract the non-flexible board 23 on the bottom of the recess 71.

When the carrier pallet 57 reaches right above the recording stage 27 and then is lifted down until the non-flexible board 23 comes into contact with the lift pins 73, the carrier pallet 57 is stopped, and then the air pipes leading to the suction pads 53 are opened to the atmosphere so as thereby to cause the suction pads 53 to release the non-flexible board 23. As a result, the non-flexible board 23 is laid on the lift pins of the recess 71 of the recording stage 27. Then, the carrying mechanism 49 moves back the carrier pallet 57 out of the image recording apparatus 21 through the egress/ingress aperture 41a of the laser shielding frame 41. On the other hand, the lift pins are retracted until the non-flexible board 23 is laid on the bottom of the recess 71, and then the offset pins are protruded to shift the non-flexible board 23 in both lengthwise and transverse directions X and Y until bringing it into abutment against the side walls of the recess 71. As a result, the non-flexible board 23 is fixedly positioned in both lengthwise and transverse directions X and Y.

Subsequently, the source of suction 55 is actuated to suck air through the suction bores so as thereby to firmly attract the non-flexible board 23 against the bottom of the recess 71. In this way, the recording stage 27 fixedly holds the non-flexible board 23 in position in the recess 71. After printing an image pattern on the non-flexible board 23 held in the recess 71 in a manner described later, the non-flexible board 23 is retrieved and carried to the board receiving unit 35 through the egress/ingress 41b 41a formed in the laser shielding frame 41 in a reverse way.

For recording an image on the non-flexible board 23, an image transfer film that is put on and in contact with the non-flexible board 23 is exposed to a light pattern formed correspondingly to a predetermined wiring pattern by a laser beam. After the exposure, an image is transferred to the non-flexible board 23 by developing the image transfer film. This makes it possible to form a quality pattern of copper conducts identical with the predetermined wiring pattern on the non-flexible board.

The image recording using the image recording apparatus 21 will be hereafter described with reference to FIGS. 11, 12(A) and 12(B). Referring to FIG. 11 showing the recording unit 39 for recording an image on the non-flexible board 23 having an image transfer film held on the recording stage 27, the recording unit 39 includes the recording stage 27 on which the non-flexible board 23 is supported and the recording head 29. The recording head 29 is movable in a plane parallel to the recording stage 27 in two directions X and Y perpendicular to each other. In this instance, the direction X is referred to as a primary scan direction, and the direction Y is referred to as a secondary scan direction. It is allowed that a scan in the primary and secondary scan directions X and Y is caused through relative movement between the recording head 27 and the recording stage 29. Although the recording head 29 may be of a single beam type that projects a single laser beam, it is preferred to use a multi-beam type that projects a plurality of laser beams arranged in a straight row. Any laser sensitive material, such as a photon mode material or a heat mode material that has a photo-thermal conversion function, may be used for the image transfer film as a dry film resist of the image recording material.

Referring to FIG. 12(A) showing an image recording material using a double layer type of photon mode dry film resist, the image recording material comprises a substrate 140 such as a glass plate or a copper-clad board or sheet and a photon mode dry film resist 120 in the form of a solid film. The dry film resist 120 comprises a transparent substrate 120a, a first photoresist layer 120b coated over the transparent substrate 120a and a second photoresist layer 120c formed over the first photoresist layer 120b. The dry film resist 120 is usually covered by a protective film before use. It is preferred to use photon mode photosensitive materials disclosed in Japanese Unexamined Patent Publication No. 2002-171902 with the consequence that through-platings of the substrate are easily covered with the photon mode photosensitive material, that a printed pattern is made with high accuracy, that a tent has high strength even though the photoresist layers are thin, and that mass productivity of printed circuit boards is improved. The dry film resist 120 is formed by coating a first photoresist layer 120b that is alkali soluble, sensitive to active energy lines and has low thermal liquidity on the transparent substrate 120a and a second photoresist layer 120c that is alkali soluble and has high thermal liquidity over the first photoresist layer 120b.

Examples of the first and second photoresist materials include a mixture of a polymer binder containing a carboxylic acid radical that is insoluble in water but soluble in an alkaline aqueous solution (which is hereafter referred to as a polymer binder for simplicity) and blended with a multifunctional monomer and an active energy line initiator. For laminating the dry film resist to a copper-clad substrate 120, it is preferred that viscosity of the second photoresist material at a laminating temperature is 10% lower than viscosity of the first photoresist material at the laminating temperature.

In the specification, the term “high thermal liquidity” as used herein shall mean that, in the process of heating the dry film resist for laminating it to the through-platings copper-clad lamination by heat at a temperature range of from 10 to 120° C. where the photoresist layers are not solidified, the dry film resist tends to become hard resulting in showing comparatively high viscosity with the consequence that the dry film resist adapts to an irregular surface of the copper-clad substrate sufficiently enough to adhere closely to it and easily sinks into the through-holes, and the term “low thermal liquidity” as used herein shall mean that, in the process of heating the dry film resist to laminate it to the through-plated copper-clad laminate, the dry film resist layer is hardly thinned due to comparatively low viscosity around annular border edges of the through-holes.

In the case where the photon mode dry film resist 120 is of a single layer type, when increasing liquidity of a photoresist layer for increasing adhesion of the dry film resist to the substrate, the photoresist layer is thinned around border edges of the through-holes. On the other hand, in the case where the photon mode dry film resist 120 is of a double layer type, while the photoresist layer is prevented from being thinned around border edges of the through-holes by decreasing the liquidity of a first photoresist material, it is possible to increase the liquidity of the photoresist material so as to provide strong adhesion of the dry film resist to the substrate. It is preferred that the first and second photoresist materials of the dry film resist used in the present invention contain a polymer binder containing a carboxylic acid radical that is hardly insoluble in water but soluble in a alkaline aqueous solution. While the first and second photoresist materials are obtained by blending the polymer binder with a polymerizable compound having more than two acrylate groups as a multifunctional monomer and an active energy line initiator, it is allowed for the first and second photoresist materials to contain an adhesion accelerator, a coloring agent, a leuco dye, an antifoaming agent, a leveling agent, a thermal polymerization inhibitor, a precipitation inhibitor, a plasticizer and/or the like as appropriate.

Thermal liquidity of the first and second photoresist materials for the dry film resist is controlled by selecting compositions and molecular weight of the polymer binder and types and additive amounts of the multifunctional monomer. That is, the thermal liquidity of the photoresist material is increased with an increase in the molecular weight of the polymer binder, with a rise in the liquidity of the multifunctional monomer before curing, and/or with a decrease in the additive amount of the multifunctional monomer. The photoresist layer is laminated by a heat roller at a temperature in a range of from 60 to 120° C. for a period of from several seconds to over ten seconds. At this time, it is preferred for the photoresist layer to have viscosity in a range of from 104 to 106 Pa·s (Pascal·second).

Examples of the polymer binder for the first and second photoresist materials that are alkali soluble and sensitive to active energy lines include conventionally available acrylic resins or methacrylic resins (which are generically named (meta)acrylic resins) that contain a photo polymerizable group or a photo dimerizable group such as an acryloyl group, a methacrylate group, an allyl group or a cinnamoyl group and are photosensitive and soluble in an alkaline aqueous solution. The polymer binder is not always essential but desirable to have a photosensitive group for enhanced tent strength and enhanced sensitivity to active energy lines.

The polymer binder used for the photoresist materials is appropriate as long as it is soluble in alkaline water in a range of from pH10 to pF14 but insoluble in water. Examples of the polymer binder include an acrylic copolymer made from an acrylic monomer containing a carboxylic acid radical and a copolymer that is obtained by reacting a resin containing a hydroxyl group such as cellulose ether or polyhydroxymethyl methacrylate with a maleic anhydrate or a phthalic anhydrate. It is preferred for the acrylic copolymer made from an acrylic monomer containing a carboxylic acid radical to be a copolymer of a monomer containing a carboxylic acid radical and another copolymerizable monomer. Examples of the monomer containing a carboxylic acid radical include (meth)acrylic acids, vinyl benzoic acids, maleic acids, maleic anhydrates, itaconi acids, itaconic anhydrates, crotonic acids, cinnamic acids, aclilic dimmers and the like.

Especially preferable examples of the polymer binder include a copolymer of methyl methacrylate and methacrylic acid (compositional polymerization ratio: 70˜80 mol %/30˜15 mol %; mass average molecular weight: 50,000˜140,000), a copolymer of benzyl methcrylate and methacrylic acid (compositional polymerization ratio: 65˜75 mol %/35˜25 mol %; mass average molecular weight: 30,000˜150,000), a copolymer of styrene and maleic acid (compositional polymerization ratio: 50˜70 mol %/50˜30 mol %; mass average molecular weight: 10,000˜200,000), a copolymer of 2-hydroxyethyl methacrylate, benzyl methacrylate and methacrylic acid (compositional polymerization ratio: 10˜30 mol %/40˜60 mol %/30˜10 mol %; mass average molecular weight: 10,000˜200,000), a copolymer of methacrylic acid, methyl methacrylate, ethyl acrylate and benzyl methacrylate (compositional polymerization ratio: 14˜30 weight %/20˜70 weight %/3˜30 weight %/3˜30 weight %; mass average molecular weight: 30,000˜300,000), and a mixture of the above polymer, styrene and (meth)acrylic acid (compositional polymerization ratio: 15˜60 weight %/45˜85 weight %/30˜10 mol %; mass average molecular weight: 1,000˜100,000). It is preferred for the photoresist layer to have the binder content between 30 and 90 weight %, more desirably between 40 and 80 weight %, and most desirably between 45 and 65 weight %. The photoresist layer encounters aggravation of processability by an alkaline developer and adhesion to the copper-clad lamination if the binder content is too low or aggravation of stability relative to developing time and strength of a cured film if, on the other hand, the binder content is too high.

The multifunctional monomer, that is an additionally polymerizable compound having at least two ethylenic unsaturated linkages, operates to keep the binder from loosing its solubility in an alkaline aqueous solution, to cause polymerization of the binder due to exposure to activation energy lines and to lower solubility of the coated layer containing the binder in an alkaline aqueous solution. It is preferred to selectively use compounds at least two ethylene unsaturated end linkages in one molecule. Typical examples are compounds having a chemical structure of a monomer, a prepolymer such as a dimmer or a trimer, an oligomer, mixtures of them or copolymers of them. Examples of the monomer or the copolymer of the monomer include ester of an unsaturated carboxylic acid (such as an acrylic acid, a methacrylic acid, an itaconic acid, a crotonic acid, isocrotonic acid, a maleic acid, etc.) and an aliphatic polyhydroxy alcohol compound and amide of an unsaturated carboxylic acid and an aliphatic polyhydroxy amine compound.

The activation energy line initiator is capable of initiating substantial photo polymerization of the multifunctional monomer. All of compounds that are capable of initiating polymerization of the above mentioned compound having at least one ethylenic unsaturated linkage and, in particular, sensitive to light in an ultraviolet region or purple light can be used as the activation energy line initiator,. Further, the activation energy line initiator may be an activator that cause some kind of action on an photo excited sensitzer to produce active radicals. Examples of the activation energy line initiator include derivatives of halogenated hydrocarbon, ketone compounds, ketoxime compounds, organic peroxides, thio compounds, hexaryl biimidazole, aromatic onium salts, ketoxime ether, etc.

Referring to FIG. 12(B) showing an image recording material using a heat mode dry film resist, the image recording material comprises a substrate 140 such as a glass plate or a copper-clad board and a thermal image transfer film 240. The image transfer film 240 comprises a substrate 240a, a photo-thermal conversion layer 240b coated over the transparent substrate 240a and a photoresist layer 240c formed over the photo-thermal conversion layer 240b. The substrate 240a may be of a general type that is capable of transmitting a laser beam. Examples of the substrate 240a include a polyethylene telephthalate (PET) sheet, a triacetyl cellulose (TAC) sheet, a polyethylene naphthalate (PEN) sheet, etc.

The photo-thermal conversion layer 240b, that converts irradiated laser energy to thermal energy, consists of a matting agent and/or other materials as appropriate in addition to a photo-thermal conversion material and a binder. The photo-thermal conversion material is typically a pigment or a dye. In the case where an infiared laser beam is used to expose the image recording material, it is preferred to use an infrared absorption pigment as the photo-thermal conversion material. Examples of the infrared absorption pigment or dye include a black pigment such as carbon black, pigments consisting of a macrocyclic compound having an absorption feature between a visible region and a near-infrared region such as phthalocyanine or naphthalocyanine, organic dyes used for a laser absorption material of a high density laser recording device such as an optical disk (e.g. cyanine dyes such as Indian rennin dye, anthraquinone dyes, azulene dyes and phthalocyanine dyes), and an organic metal compound pigments such as dithiolic nickel complexes. It is preferred to use a cyanine pigment that has a high absorptivity for radiation in an infrared region for the photo-thermal conversion material with the consequence that the photo-thermal conversion layer is thinned and the thermal transfer sheet is provided with enhanced photo sensitivity. It is allowed to use even materials other than pigments such as inorganic materials, for example particulate metal such as blackened silver, for the photo-thermal conversion material. In addition, it is also allowed to use any material capable of converting light energy into thermal energy such as carbon, black materials, infrared absorption pigments, materials capable of absorbing light in a specific region of wavelengths.

Recording an image on the non-flexible image recording material is performed using the image recording apparatus shown in FIGS. 9 and 10. After carrying the non-flexible substrate 23 from the feeder unit 33 and setting it in position on the recording stage 27, a image transfer film, i.e. a dry film resist, is supplied from the image transfer film feeder unit 31 and is superposed on the non-flexible substrate 23 in close contact with each other. The recording head 27 or the recording stage 27 is driven to scan the image recording material (the non-flexible substrate 23 and the image transfer film) with laser beams having a wavelength in a range of from 250 to 500 nm that meets the absorptive wavelength of the photosensitive material of the image transfer film or dry film resist according to red, green and blue image data. After the scan, the transparent substrate is peeled off from the non-flexible substrate 23. When developing the image recording material, there is formed an exposed pattern of the dry film resist left on the non-flexible board 23.

When printing a circuit on a board using the image recording apparatus 21 described above, the image recording material comprising a cupper-clad board and an image transfer film, i.e. a dry film resist in the form of solid film, superposed on the cupper-clad board is fixedly placed on the recording stage 27 and exposed to a light pattern corresponding to a predetermined wiring pattern using the recording head 29. The exposure is performed by moving the recording stage 27 and the recording head relatively to each other to scan the image recording material in the primary and secondary scan directions X and Y. FIG. 13(A) shows a part of an output image of the wiring pattern recorded by the image recording apparatus 21 that is a bit map image at 5080 bits per inch (pdi) which typically states the resolution of bit map image. As shown, the output bit map image is accompanied by straight border lines or border edges in the primary and secondary scan directions (horizontal and vertical straight lines or border edges) which are clear or smooth and oblique border lines or border edges, straight or curved, in oblique directions that are jagged or stepped like a stair. The size of a jag is approximately 5 μm. When an image of a printed circuit pattern is accompanied by such a jagged or stairstep border edge, the printed circuit as an end product is possibly not uniform in impedance for signals higher than, for example, 100 MHz. Further, the printed circuit having a jagged or stairstep border edge easily breaks away at jags and results in a breakdown.

In order to eliminate these problems, it is conceivable effective to scan at pitches of, for example, 5 μm smaller than a dot size with the consequence of casting jags into the shade. FIG. 13(B) shows a part of an output image of a wiring pattern produced in that manner by the image recording apparatus 21 that is a bit map image having a resolution of 5080 pdi. As apparent, jags accompanying the output image are microscopic, so that the printed circuit as an end product has less possibility of having non-uniform impedance for high frequency signals and is prevented from breaking away at a jagged or stairstep border edge.

However, admitting that jags are fine, the printed circuit as an end product remains unchanged in still having jagged border edges. Therefore, it is still feared that the printed circuit as an end product possibly has non-uniform impedance for high frequency signals and breaks away at jags. In addition, the scan needs a scan time ten times as long as a scan at a standard resolution.

### SUMMARY OF THE INVENTION

It is therefore an object of the present invention to provide a method and an apparatus for recording a jag-free image o a circuit pattern so that the printed circuit as an end product runs stably on high frequency signals, is prevented from breaking away, and is produced in less time.

The above object of the present invention is accomplished by a method of recording an image on an image recording material fixedly placed on a recording stage by scanning the recording material with a light beam projected by the recording head to record an image on the recording material. The method of recording an image comprises the steps of moving relative movement between the recording head and the recording stage in primary and secondary scan directions perpendicular to each other in a plane in parallel to the recording material to form an image to scan the recording material so as thereby to form an image on the recording material; and making relative movement between the recording head and the recording stage in an oblique direction along an oblique border edge of the image out of alignment with the primary and secondary scan directions to scan the oblique border line, either after or before recording the image on the image recording material, to smooth a jagged border of the image. The laser beam is activated when relative movement between the recording head and the recording stage achieves a constant speed.

The recording head may be adapted to project a plurality of light beams in alignment with either one of the primary and secondary scan directions and project selectively light beams to scan the oblique border lines of the images lying in parallel to each other to smooth jagged borders of the images simultaneously.

The method of recording an image on an image recording material is performed by an image recording apparatus which comprises a recording stage for fixedly placing an image recording material, optical scanning means for optically scanning the image recording material with a light beam in primary and secondary scan directions perpendicular to each other in a plane in parallel to a surface of the recording material, and control means for controlling relative movement between the optical scanning means and the recording stage based on data on the image so as thereby to print an image on the image recording material. The control means comprises image data memory means for storing the data on an image to be printed on the image recording material, border line detection means for extracting data on an oblique border line of the image that is out of alignment with the primary and secondary scan directions from the image data, and border line data memory means for storing the border line data extracted from the image data. The control means controls relative movement between the recording head and the recording stage in an oblique direction out of alignment with the primary and secondary scan directions so that the optical scanning means scans oblique lines along the oblique border line of the image based on the border line data, either after or before printing the image on the image recording material, to smooth an oblique jagged border line of the image.

### BRIEF DESCRIPTION OF THE DRAWINGS

The foregoing and other objects of the present invention will be clearly understood from the following detailed description when read with reference to the accompanying drawing, in which:

FIG. 1 (A) is an illustration showing an image produced in a first scanning step of an image recording method according to a preferred embodiment of the present invention;

FIG. 1(B) is an illustration showing an image produced in a second scanning or smoothing step of the image recording method;

FIG. 2 is a block diagram illustrating a controller of an image recording apparatus for implementing the image recording method;

FIG. 3(A) is an illustration showing an image produced in a first scanning step of an image recording method according to a second preferred embodiment of the present invention;

FIG. 3 (B) is an illustration showing an image produced in a second scanning or smoothing step of the other image recording method of the second embodiment;

FIG. 4(A) is an illustration showing an image produced in a first scanning step of an image recording method according to a third preferred embodiment of the present invention;

FIG. 4(B) is an illustration showing an image produced in a second scanning or smoothing step of the image recording method of the third embodiment;

FIG. 5(A) is an illustration showing an image produced in a first scanning step of an image recording method according to a fourth preferred embodiment of the present invention;

FIG. 5 (B) is an illustration showing an image produced in a second scanning or smoothing step of the image recording method of the fourth embodiment;

FIG. 6(A) is an illustration showing an image produced in a first scanning step of an image recording method according to a fifth preferred embodiment of the present invention;

FIG. 6(B) is an illustration showing an image produced in a second scanning or smoothing step of the image recording method of the fifth embodiment;

FIG. 7(A) is an illustration showing an image produced in a first scanning step of an image recording method according to a sixth preferred embodiment of the present invention;

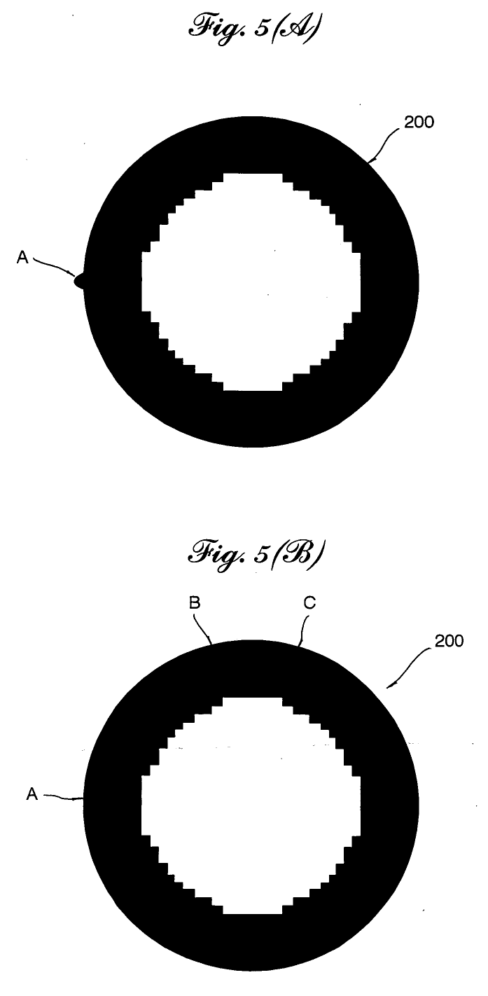

FIG. 5(B) is an illustration showing an image produced in a second scanning or smoothing step of the image recording method of the sixth embodiment;

FIG. 8 is a schematic illustration showing the process of producing a printed circuit board;

FIG. 9 is a plane view of an image recording apparatus for implementing the image recording method of the present invention;

FIG. 10 is a front view of the image recording apparatus;

FIG. 11 is a perspective view of a recording unit of the image recording apparatus;

FIG. 12(A) is an exploded view of a photon mode image recording material;

FIG. 12(B) is an exploded view of a heat mode image recording material;

FIG. 13(A) is an illustration showing an image produced using a conventional image recording method; and

FIG. 13(B) is an illustration showing an image produced using a conventional but improved image recording method.

### DETAILED DESCRIPTION OF THE PREFERRED EMBODIMENT

An image recording method for recording an image on a recording material according to an embodiment of the present invention will hereafter be described with referring to the drawings in detail. In the embodiment, the image recording method is used to expose a photoresist layer of a non-flexible substrate to an image of a predetermined circuit pattern in a conventional process of producing a printed circuit board. The exposure is performed basically in the conventional manner.

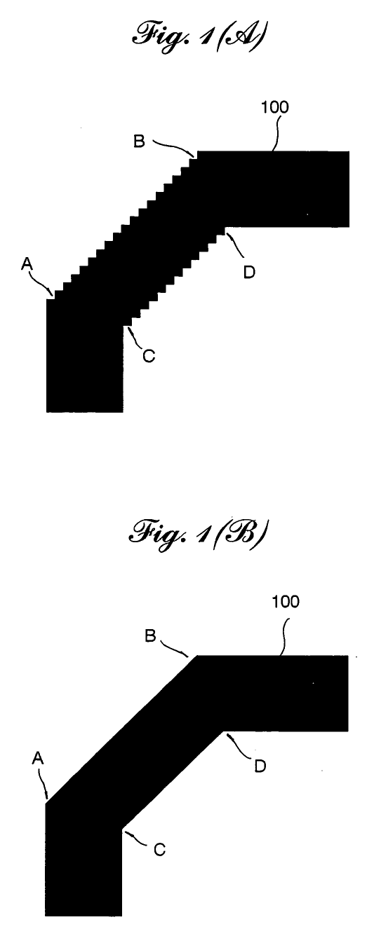

Referring to FIGS. 1(A) and l(B) showing a process of the image recording method suitably applied to recoding an image of a predetermined circuit pattern including a solid line bordered with oblique border edges, the image recording method comprises two steps, namely a first scanning step for recording an image of the predetermined circuit pattern using a bitmap image as in the past and a second scanning or smoothing step for recording oblique lines over stairstep or jagged oblique border lines or border edges of the image to smooth the stairstep or jagged oblique border lines or border edges.

As shown in FIG. 1(A), a solid line 100 forming part of the circuit pattern recorded in a conventional method in the first scanning step is bordered with clear border edges in the primary and secondary directions and with stairstep or jagged oblique border edges between points A and B and between points C and D in oblique directions. In the smoothing step, clear lines are recorded over the jagged oblique border edges of the solid line 100 between the points A and B and between the points C and D. Specifically, the recording head and the recording stage are relatively moved in an oblique direction at a constant line speed to scan the recording material along the jagged oblique border edge of the solid line 100 with a laser beam. In consequence, the solid line 100 bordered partly with jagged oblique border edges is reformed as completely bordered with smoothed or clear border edges as shown in FIG. 1(B).

A printed circuit that is produced using the image recording method is bordered with smoothed or clear border edges over all-around. Therefore, the printed circuit as an end product is uniform in impedance even at oblique border edge portions, so that the printed circuit as an end product runs stably on high frequency signals higher than, for example, 100 MHz. Further, the printed circuit is prevented from peeling off and having a breakdown in consequence.

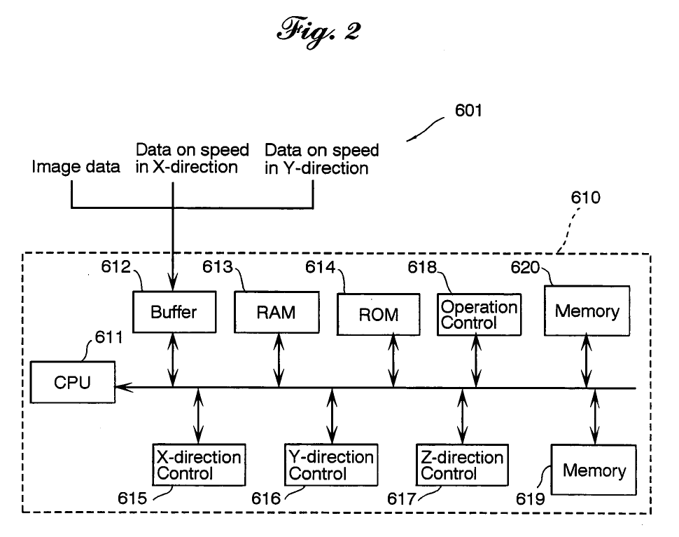

Referring to FIG. 2 showing a recording head controller for controlling the recording head to scan a jagged oblique border edge of a solid line of an image, the controller 610 comprises CPU 611, a buffer memory 611 for temporarily storing graphic data that are provided by a graphic image creating device 601, RAM 613 for storing operational parameters and the like for the controller 610, ROM 614 for storing plotting programs, lockup tables and the like, recording head controllers 615, 616 and 617 for controlling relative movement between the recording head and the recording stage in an X direction (the primary scan direction), a Y direction (the secondary scan direction) and a Z direction (oblique scan direction), respectively, a recording head operator 618 for operating the recording head and jagged border edge data memory 619 for storing data of information on jagged border edges.

In the first scanning step, graphic data prepared by the graphic image creating device 601 and temporarily stored in the buffer memory 612 are retrieved and converted into control signals for the recording head. The recording controllers 615, 616 and 617 control relative movement between the recording head and the recording stage in the X, Y and Z scan directions according to the control signals to record an image according to the conventional method as shown in FIG. 1(A).

In the smoothing step, CPU 611 makes out the graphic data to detect stairstep or jagged oblique border edges of the solid line 100 that has been recorded or is to be recorded. The detection of stairstep or jagged border edge aims at determining the presence and the direction of jagged border edges in the following manner. When a first or starting pixel or a last or terminal pixel of a previous scan line is identical in position in the primary scan direction X with that of a current scan line, it is determined that the two line segments have no jags between leading ends or trailing ends thereof. On the other hand, when a first pixel or a last pixel of a previous scan line is not identical in position in the primary scan direction X with that of a current scan line, it is determined that the two scanned line segments has a jag between leading ends or trailing ends thereof. Whenever a jagged border edge is detected, data of positional information on the starting pixels or the terminal pixels of each two adjacent scan lines are stored in the jagged border edge data memory 619. The same operation is repeated for all of adjacent scan lines implemented to record a solid line 100 such as shown in FIG. 1(A). The data of positional information on pixels are divided into two groups for starting pixels and terminal pixels. The data of positional information on pixels of each group are further divided into sub-groups for clusters of seriate pixels in the secondary scan direction Y The recording head controllers 615, 616 and 617 cause relative movement between the recording head and the recording stage in the X, Y and Z directions, respectively, according to the data of positional information on pixels of each sub-group to bridge the jags one by one so as thereby to smooth the jagged oblique border edges of the solid line 100 such as shown in FIG. 1(B).

It is preferred to record an image at a uniform speed of relative movement between the recording head and the recording stage in the smoothing process. When scanning the jagged oblique border edge of the solid line 100 from the point A to the point B in FIG. 1(A), relative movement between the recording head and the recording stage in the X, Y and Z directions is caused in the following sequence. For a start, the recording head is positioned so as to bring a path of a laser beam in alignment with the position A, and then the laser beam is activated. Subsequently, the recording head is moved along the jagged oblique border edge of the solid line 100 from the point A to the point B to scan the jagged oblique border edge of the solid line 100 and then the laser beam is deactivated.

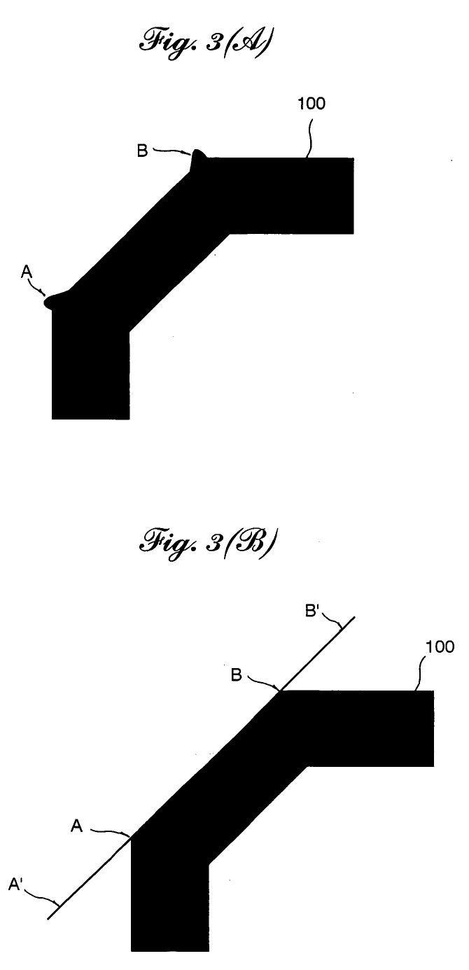

In this context, when making a rigorous observation, the level of laser energy that impinges upon the recording material is higher at the points A and B than the remaining portion, so that the output image possibly bulges out locally at the points A and B as shown in FIG. 3(A). When an electric circuit has such bulges, there occurs the fear that the electric circuit is non-uniform in impedance for high frequency signals and breaks away at these points.

This problem is eliminated by providing acceleration and deceleration zones for a scan line as shown in FIG. 3(B). Specifically, when smoothing a jagged oblique border edge of the solid line 100 from a point A to a point B such as shown in, for example, FIG. 1(A), the relative movement between the recording head and the recording stage in the X, Y and Z directions is caused in the following sequence. For a start, the recording head is positioned so as to bring a path of a laser beam in alignment with a point A′ on a lower or starting side extension of a line connecting extreme end points A and B of the jagged oblique border edge. Subsequently, the recording head is controlled to move along the jagged oblique border edge of the solid line 100 toward the point A at an accelerating speed so as to attain a specified uniform speed before reaching the point A. As soon as attaining the specified uniform speed, the laser beam is energized upon passing the point A and kept activated until reaching the point B, thereby scanning a clear line along the jagged oblique border edge of the solid line 100. Further, after deactivating the laser beam at the point B, the recording head is decelerated so as to stop at the point B′ on an upper or terminal side extension of the line L.

In this way, the level of laser energy that impinges upon the recording material is equalized over the entire length of the oblique border edge between the points A and B, so that the output image has no bulge even locally at the points A and B as shown in FIG. 3(B). In consequence, the electric circuit is equable in impedance and operates stably even for high frequency signals higher than, for example, 100 MHz and is prevented from breaking away at the points A and B.

The recording head speed control at the start of scan will be explained with reference to FIG. 2.

As shown, the speed data memory 620 stores data on stationary speeds of the recording head in the X and Y directions. Data on recording head speeds in the X and Y directions are sent to CPU 611 through the buffer memory 612. Speeds of the recording head in the X and Y directions may be provided by, for example, encoders directly connected to shafts of motors for driving the recording head in the X and Y directions, respectively. CPU 611 calculates current speeds in the X and Y directions from point to pint and compares them with the stationary speeds in the X and Y directions that are stored in the speed data memory 620. As soon as the current speeds of the recording head in the X and Y directions reach the stationary speeds in the X and Y directions, respectively, the laser beam is activated to start a scan.

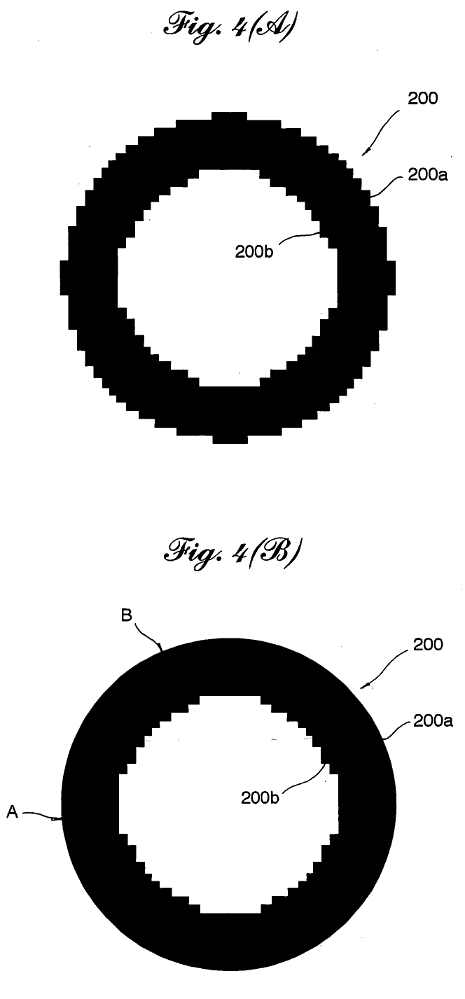

Referring to FIGS. 41(A) and 4(B) showing an image recording method according to another embodiment of the present invention which is suitably used to form a jag-free image of a given circular sold line, the image recording method comprises two steps, namely a first scanning step for recording a circular solid line 200 using a bit map image as in the past and a second scanning or smoothing step for recording circular lines along stairstep or jagged outer and inner circular border lines or edges of the circular solid line 200.

As shown in FIG. 4(A), an image of a circular solid line 200 recorded in the conventional way in the first scanning step is bordered with stairstep or jagged outer and inner circular border edges 200a and 200b. In the second scanning or smoothing step, circular lines are recorded along the jagged outer and inner circular border edges 200a and 200b. Specifically, for a start, the recording head is positioned so as to bring a path of a laser beam in alignment with a predetermined point A on the jagged outer circular border edge 200a, and then the laser beam is activated. Subsequently, the recording head is moved along the jagged outer circular border edge 200a until making an entire round of the circular solid line 200 passing through a point B. When returning to the point A, the laser beam is deactivated. In this way, the jagged outer circular border edge 200a is over scanned and smoothed. The smoothing step is implemented for the jagged inner circular border edge 200b.

The printed circuit as an end product that is produced by a process including the image recording method is uniform in impedance all along the circular solid line, so that the printed circuit runs stably on high frequency signals higher than, for example, 100 MHz. Further, the printed circuit bordered with clear edges is prevented from peeling off and breaking away at its outer and/or inner edges.

It is preferred to record an image at a specified uniform speed of relative movement between the recording head and the recording stage in the smoothing process. When recording a circular line along an outer circular border edges 200a of the circular solid line 200, the controller moves the recording head to a predetermined point A on the outer circular border edge 200a of the circular solid line 200 and then activates the laser beam at the point A. Consequently, the controller moves the recording head so that the laser beam makes an entire round of the circular solid line 200. When the laser beam returns to the point A, the laser beam is deactivated.

In this context, when making a rigorous observation, the level of laser energy that impinges upon the recording material is higher at the point A than the remaining portion, so that the output image possibly bulges out locally at the point A as shown in FIG. 5(A). This problem is eliminated by providing acceleration and deceleration zones for a scan line. Specifically, as shown in FIG. 5(B), when smoothing a jagged circular border edge of the circular solid line 200, the recording head is controlled to move to the point A on the jagged outer circular border edge 200a of the circular solid line 200 and further along the jagged outer circular border edge 200a of the circular solid line 200 toward a specified point B at an accelerating speed. When the recording head attains a specified uniform speed at a point C, the laser beam is activated. Thereafter, the recording head is continuously moved at the specified uniform speed with the laser beam remaining activated until returning to the point C passing through the points A and B. When reaching the point C, the laser beam is deactivated and the recording head is decelerated to come to a halt.

In this way, the level of laser energy that impinges upon the recording material is equalized over the entire length of the circular border edge including the points A, B and C, so that the output image has no bulge even locally at the points A, B and C as shown in FIG. 5(B) and is bordered with smoothed or clear circular border edge. In consequence, the electric circuit as an end product is equalized in impedance and operates stably even for high frequency signals higher than, for example, 100 MHz and is prevented from breaking away.

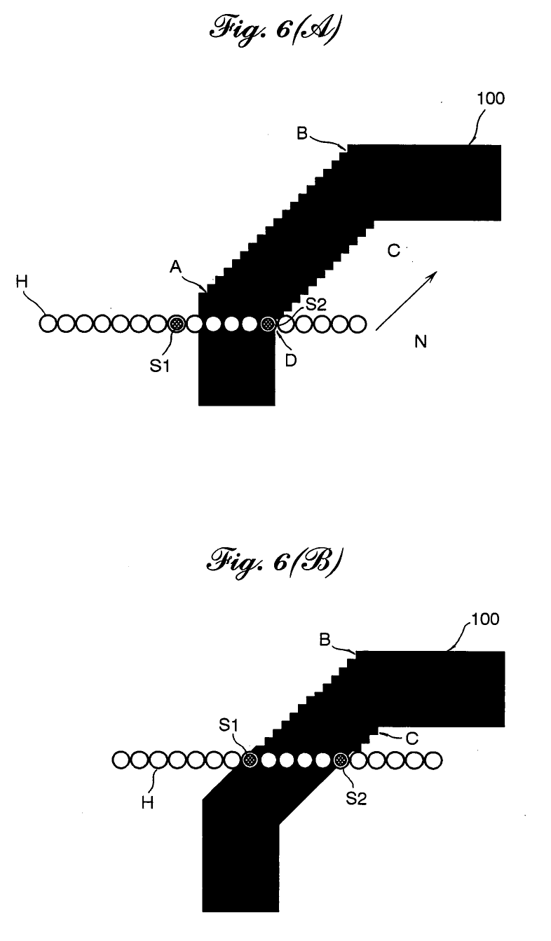

FIGS. 6(A) and 6(B) show the jag-free image recording method according to another embodiment of the present invention in which a row of laser beams H are use. FIG. 6(A) shows a state before smoothing jagged oblique border edges of a solid line 100 that is recorded by the conventional way, and FIG. 6(B) shows a state during smoothing the jagged oblique border edges of the solid line 100. As shown, the recording head is adapted to provide a row of 18 laser beams H arranged side by side in the X direction. In this embodiment, the recording head is moved relatively to the recording stage in an oblique direction (N direction). When the recording head is moved in the oblique direction N and reaches a position D in alignment with a first or lower extreme jag of one of the jaggy oblique border edges of the solid line 100 in the Y direction, one laser beam S2 of the row of laser beams H that corresponds in position to the first jag of the one jagged oblique border edge is activated. Further, when the recording head reaches a position A in alignment with a first or lower extreme jag of another one of the jaggy oblique border edges of the solid line 100 in the Y direction, another one S1 of the row laser beams H that corresponds in position to the first jag of the other jagged oblique border edge. While the recording head is continuously moved in the N direction, the jagged oblique border edges of the solid line 100 are smoothed simultaneously as shown in FIG. 6(B). When the recording head reaches a position C in alignment with a last or upper extreme jag of the one jagged oblique border edge of the solid line 100, the laser beam S2 is deactivated to disappear. Further, when the recording head reaches a position B in alignment with a last or upper extreme jag of the other jagged oblique border edge of the solid line 100, the laser beam S1 is deactivated to disappear. In this way, the jagged border edges of the solid line 100 are smoother simultaneously in one scan.

In this embodiment, it is preferred to provide acceleration and deceleration zones like the previous embodiment shown in FIG. 3(B). Specifically, until the recording head reaches a point A on a lower or starting side extension of a line (not shown) connecting extreme end points A and B or C and D of the jagged oblique border edge of the solid line 100, the recording head is moved toward a point D corresponding to the first jag at an accelerating speed to attain a specified uniform speed. When having attained the specified uniform speed before reaching the point D, the laser beam S2 is activated upon passing the point D as shown in FIG. 2(A). When the recording head moving at the specified uniform speed reaches a point A corresponding in position to the first jag of the other jagged oblique border edge of the solid line 100, the laser beam S1 is activated as shown in FIG. 2(B). While the recording head is moving at the specified uniform speed, the laser beam spot S2 is deactivated to disappear when passing the point C corresponding to the last jag, and subsequently the laser beam S1 is deactivated to disappear when passing the point B corresponding to the first jag. After having passed the point A, the recording head is decelerated so as to come to a halt until reaching a specified point on an upper or terminal side extension of a line (not shown) connecting the points A and B.

In that way, in addition to the realization of shortened exposure time, the level of laser energy that impinges upon the recording material is equalized over the entire lengths of the oblique border edges including the points A, B, C and D, so that the output image of the solid line 100 has no bulges like that shown in FIG. 3(B) locally at the points A, B, C and D.

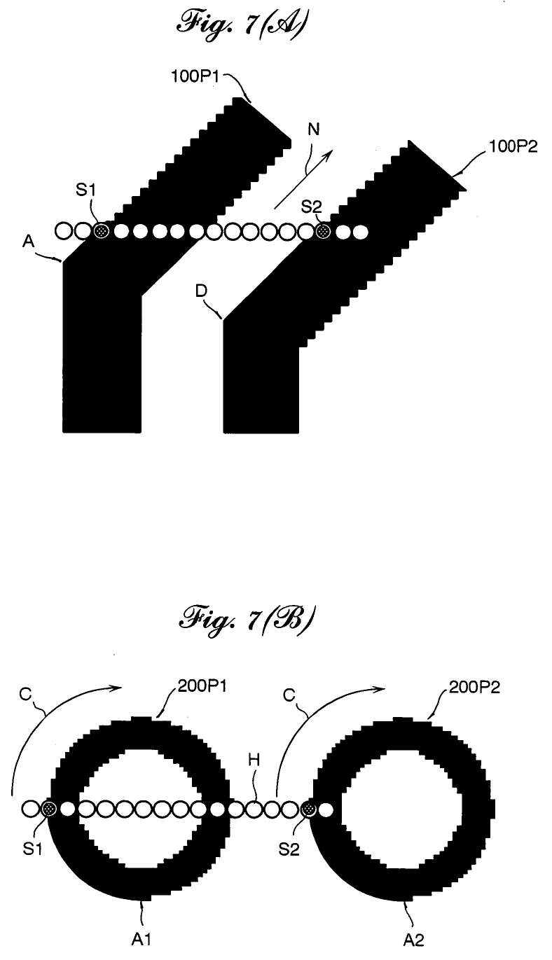

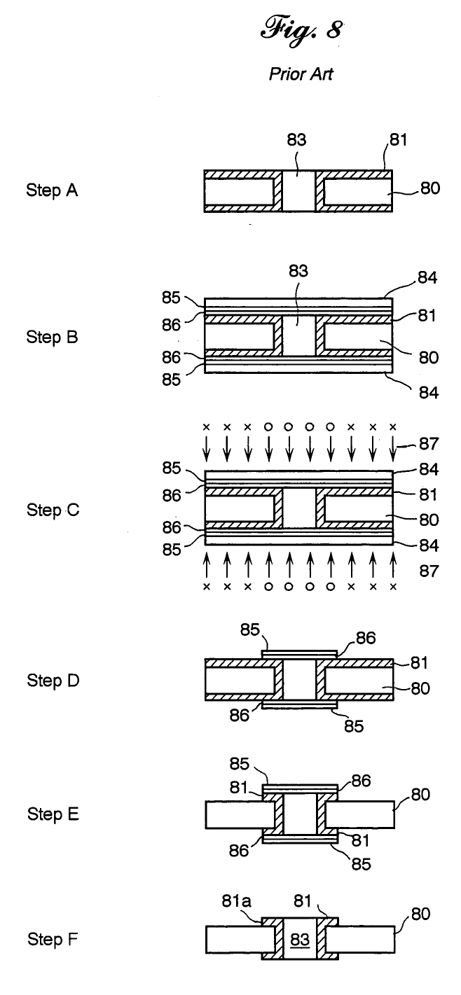

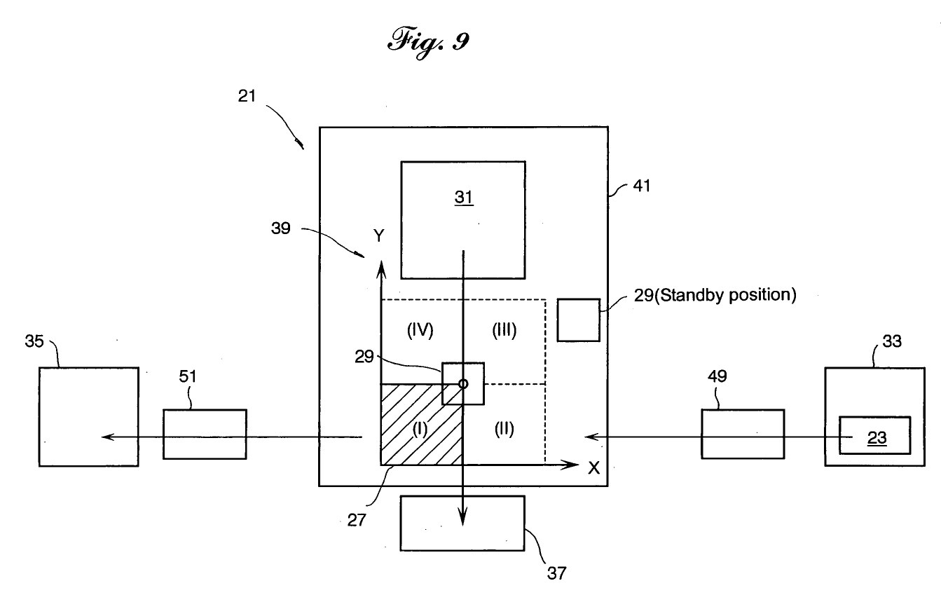

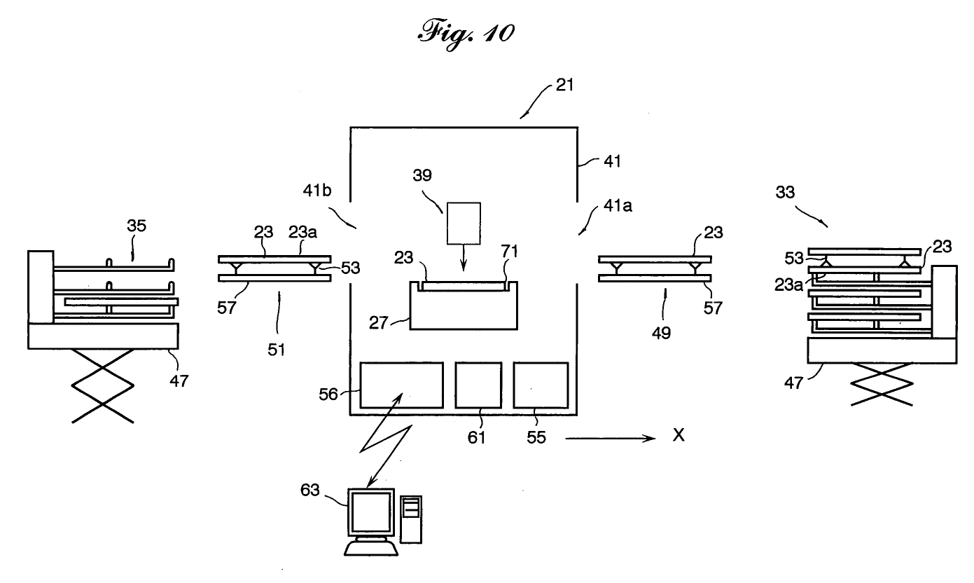

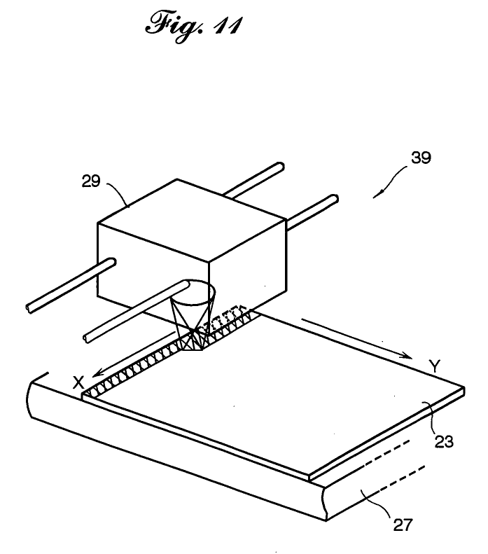

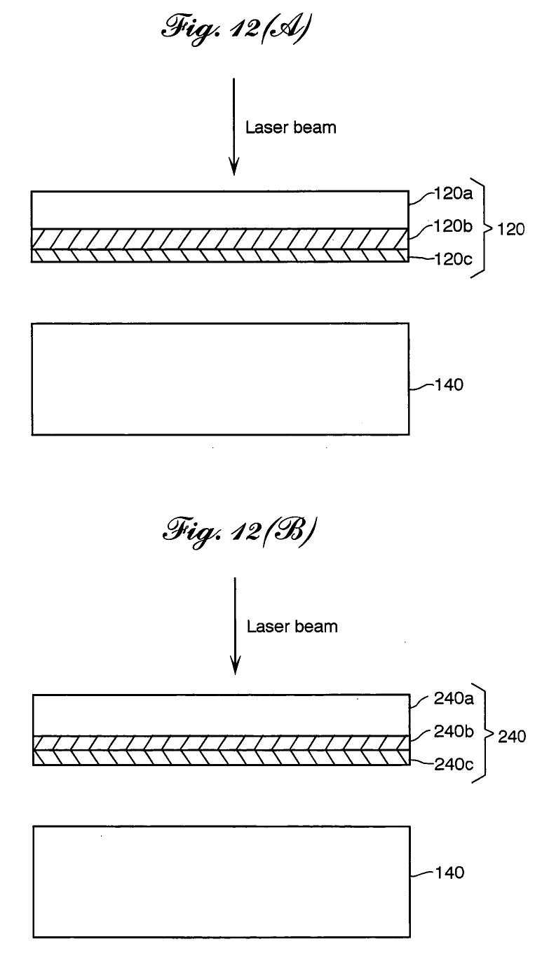

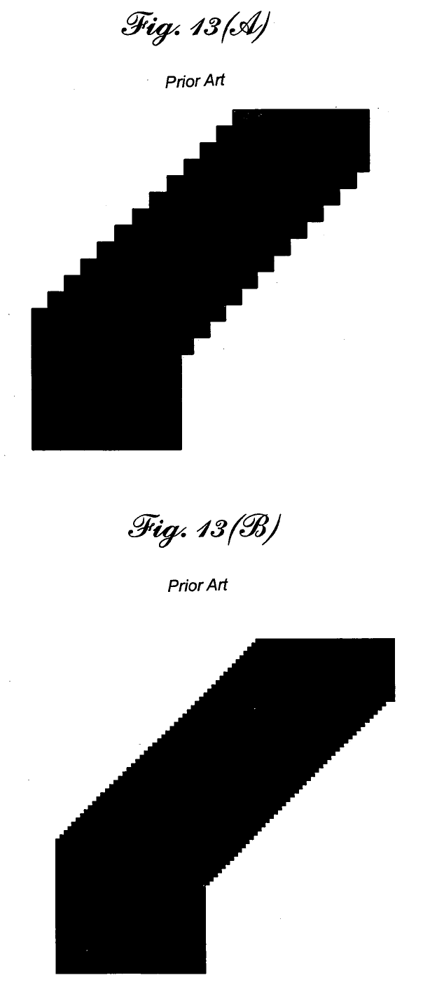

FIGS. 7(A) and 7(B) show a variation of the jag-free image recording method in which a row of laser beam are use. FIG. 7(A) shows a state during smoothing jagged oblique border edges of two, namely first and second, solid lines 100P1 and 100P2 simultaneously, and FIG. 7(B) shows a state during smoothing jagged circular border edges of two, namely first and second, circular solid lines 200P1 and 200P2 simultaneously. As shown in FIG. 7(A), the recording head is adapted to provide a row of 18 laser beams H arranged in the X direction so as to extend across outer oblique border edges of the first and second circular solid lines 100P1 and P2. In this embodiment, the recording head is moved relatively to the recording stage in an oblique direction N. When the recording head reaches a point D in alignment with a first or lower extreme jag of a jagged outer oblique border edge of the second circular solid line 100P2 in the Y direction, one laser beam S2 of the row of laser beams H that corresponds in position in the Y direction to the first extreme jag. Further, when the recording head reaches a point A in alignment with a first or lower extreme jag of a jagged outer oblique border edge of a first circular solid line 100P1 in the Y direction, another laser beam S 1 that corresponds in position in the Y direction to the first jag is activated. While the recording head is continuously moved in the N direction, the laser beams S1 and S2 scan the jagged outer oblique border edges of the first and second solid lines 100P1 and 100P2, respectively. In this way, the jagged oblique border edges of the two solid lines 100P1 and 100P2 are smoother simultaneously in one scan.

As shown in FIG. 7(B), the recording head is adapted to provide a row of 18 laser beams H arranged in the X direction so as to extend across outer circular border edges of first and second circular solid lines 200P1 and 200P2 arranged side by side. In this embodiment, the recording head is moved relatively to the recording stage so as to bring the row of laser beams H in alignment with bottom points A1 and A2 of jagged outer circular border edges of the first and second circular solid lines 200P1 and 200P2, and then two laser beams S1 and S2 corresponding in position to the bottom points A1 and A2 of the first and second circular solid lines 200P1 and 200P2, respectively, are activated. Subsequently, the recording head is moved along the outer circular border edges of the first and second circular solid lines 200P1 and 200P2 as indicated by arrows C until making an entire round of the circular solid lines 200P1 and 200P2. When the laser beams S1 and S2 return to the bottom points A1 and A2 respectively, the laser beams S1 and S2 are deactivated. In this way, the jagged outer circular border edges of the first and second circular solid lines 200P1 and 200P2 are smoothed simultaneously in one scan with the consequence that the scan time is shortened.

In these embodiments, it is preferred to provide acceleration and deceleration zones like the previous embodiments shown in FIG. 3(B) and FIG. 5(B) with the consequence that the output image has no bulge locally in the smoothing step.

According to the jag-free image recording method of the invention, a jag-free image is recorded on a heat mode image recording material having a photo-thermal conversion layer as well as the photon mode image recording material by using a laser beam or laser beams. Although a scanning speed is dependent upon laser power and/or a beam size, it is preferred to be in a range from 0.01 to 40 m/second. Although it is essential for the image recording method that data on a bit map image and data on border lines or edges of an recorded image are prepared beforehand, the border edge data of the image may be created based on the bit map image data during recording the image. Since, in the recent years, it is general to design a wiring pattern of a printed circuit by means of CAD, it is possible to create raster image data (bit map image data) from CAD data that originally contains contour data. In this case, an image is recorded by performing a raster scan first using the raster image data and then a vector scan using the contour data in this order or in reverse.

It is to be understood that although the present invention has been fully described by way of the preferred embodiments thereof with reference to the accompanying drawings, various variant and other embodiments may occur to those skilled in the art. Unless these variants and embodiment depart from the scope of the present invention, they are intended to be covered by the following claims.

What is claimed is:

1. A method of recording an image on an image recording material fixedly placed on a recording stage by scanning the recording material with a light beam projected by the recording head to record an image on the recording material, said method of recording an image comprising the steps of:
moving relative movement between the recording head and the recording stage in primary and secondary scan directions perpendicular to each other in a plane in parallel to the recording material to form an image to scan the recording material so as thereby to form an image on the recording material; and
making relative movement between the recording head and the recording stage in an oblique direction along an oblique border line of said image out of alignment with said primary and secondary scan directions to scan said oblique border line, either after or before forming said image on the image recording material, to smooth a jagged border of said image.

2. A method of recording an image on an image recording material as defined in claim 1, wherein said recording head energizes a light beam when a relative speed between the recording head and the recording stage becomes constant.

3. A method of recording an image on an image recording material as defined in claim 2, wherein said recording head is capable of projecting a plurality of light beams in alignment with either one of said primary and secondary scan directions and energizes selectively said light beams to scan said oblique border lines to smooth jagged borders of said images lying in parallel to each other.

4. An apparatus for recording an image on an image recording material which comprises a recording stage on which an image recording material is fixedly placed, optical scanning means for optically scanning the image recording material with a light beam in primary and secondary scan directions perpendicular to each other in a plane in parallel to the recording material and control means for controlling relative movement between the optical scanning means and the recording stage based on data on the image so as thereby to print the image on the image recording material, said control means comprising:
image data memory means for storing the data on an image to be printed on the image recording material;
border line detection means for extracting data on an oblique border line of said image that is out of alignment with the primary and secondary scan directions from said image data
border line data memory means for storing said border line data extracted from said image data;
wherein said control means controls relative movement between the recording head and the recording stage in an oblique direction out of alignment with the primary and secondary scan directions so that said optical scanning means scans oblique lines along said oblique border line of said image based on said border line data, either after or before printing said image on the image recording material, to smooth an oblique jagged border line of said image.
